(19) United States
(12) Patent Application Publication
(10) Pub. No.: US 2024/0422234 A1
(43) Pub. Date: Dec. 19, 2024

(54) NETWORK NODES AND METHODS THEREIN FOR APPLICATION SERVER MONITORING

(71) Applicant: Telefonaktiebolaget LM Ericsson (publ), Stockholm (SE)

(72) Inventors: Wenliang Xu, Shanghai (CN); Hubert Przybysz, Hägersten (SE)

(21) Appl. No.: 18/708,307

(22) PCT Filed: Oct. 12, 2022
(86) PCT No.: PCT/CN2022/124743

§ 371 Date: May 8, 2024

(30) Foreign Application Priority Data
Nov. 10, 2021 (WO) PCT/CN2021/129896

(51) Int. Cl. H04L 67/51; G06F 8/65

(52) U.S. Cl. CPC H04L 67/51; G06F 8/65

(57) ABSTRACT

The present disclosure provides a method in an Application Programming Interface ‘API’ Management Function, AMF. The method includes: transmitting, to a Common API Framework ‘CAPIF’ Core Function, CCF, a registration request or registration update request containing API Exposing Function, AEF, information on an AEF. The AEF information includes a status of the AEF.

### CROSS-REFERENCE TO RELATED APPLICATION(S)

This application claims priority to the PCT International Application No. PCT/CN2021/129896, entitled “NETWORK NODES AND METHODS THEREIN FOR APPLICATION SERVER MONITORING”, filed on Nov. 10, 2021, which is incorporated herein by reference in its entirety.

### TECHNICAL FIELD

The present disclosure relates to communication technology, and more particularly, to network nodes and methods therein for Application Server (AS) monitoring.

### BACKGROUND

With the growing interest in the 3rd Generation Partnership Project (3GPP) to develop northbound Application Programming Interfaces (APIs), a Common API Framework (CAPIF) allows for a consistent development of northbound APIs across multiple working groups, i.e., for defining northbound APIs to abstract or expose the underlying 3GPP network capabilities to the 3rd party applications. The CAPIF offers a common framework for northbound APIs with respect to API registration, authentication, discovery, logging, and charging.

The 3GPP Technical Specification (TS) 23.222, V17.5.0, which is incorporated herein by reference in its entirety, defines functional architecture and information flows to support CAPIF. FIG. 1 shows a functional model for the CAPIF to support 3rd party API providers. As shown, a CAPIF Core Function (CCF) in a Public Land Mobile Network (PLMN) trust domain supports service APIs from both the PLMN trust domain and a 3rd party trust domain having business relationship with PLMN. API invokers may exist within the PLMN trust domain, or within the 3rd party trust domain or outside of both the PLMN trust domain and the 3rd party trust domain. The API provider domain 1 offers the service APIs from the PLMN operator. The API provider domain 2 offers the service APIs from the 3rd party. When the 3rd party API provider is a trusted 3rd party of the PLMN, the API provider domain 1 also offers the service APIs from the 3rd party. The API invoker 2 within the PLMN trust domain interacts with the CCF via CAPIF-1, and invokes the service APIs in the PLMN trust domain via CAPIF-2 and invokes the service APIs in the 3rd party trust domain via CAPIF-2e. The API invoker 3 within the 3rd party trust domain interacts with the CCF via CAPIF-1e, and invokes the service APIs in the PLMN trust domain via CAPIF-2e and invokes the service APIs in 3rd party trust domain via CAPIF-2. The API invoker 1 from outside the PLMN trust domain and 3rd party trust domain, interacts with the CCF via CAPIF-1e and invokes the service APIs in the PLMN trust domain and the service APIs in the 3rd party trust domain via CAPIF-2e. The API Exposing Function (AEF), the API Publishing Function (APF) and the API Management Function (AMF) of the API provider domain 1 within the PLMN trust domain interacts with the CCF via CAPIF-3, CAPIF-4 and CAPIF-5 respectively. The AEF, the APF, and the AMF of the API provider domain 2 within the 3rd party trust domain interacts with the CCF in the PLMN trust domain via CAPIF-3e, CAPIF-4e and CAPIF-5e respectively. The AEF within the PLMN trust domain and the 3rd party trust domain provides the service APIs to the API invoker, offered by the respective trust domains. The interactions between the AEFs within the PLMN trust domain is via CAPIF-7. The AEF within the PLMN trust domain interacts with the AEF in the 3rd party trust domain via CAPIF-7e.

FIG. 2A shows an architectural model for the CAPIF interconnection which allows API invokers of a CAPIF provider to utilize the service APIs from the 3rd party CAPIF provider. FIG. 2B shows the architectural model for the CAPIF interconnection within the same CAPIF provider domain, which allows API invokers of CCF 1 to utilize the service APIs from CCF 2, where both CCF 1 and CCF 2 are hosted within the trust domain of the CAPIF provider A. The CAPIF provider A and CAPIF provider B host the CAPIF in their trust domains. A business relationship exists between the CAPIF providers. The CAPIF providers in their respective trust domain hosts multiple CAPIF instances where each CAPIF instance consists of the CCF (local), the API provider domain and the API invokers. When multiple CAPIF instances are deployed by a CAPIF provider there may be a hierarchy associated with the multiple CCFs deployed which allows:
the designated CCF of the CAPIF provider A to interconnect with the designated CCF of the CAPIF provider B; and
within CAPIF provider A, one or more CCFs interact with the designated CCF 1.

The designated CCF of the CAPIF provider A provides the information about the CAPIF instances and service APIs deployed by the CAPIF provider A to the designated CCF of the CAPIF provider B and vice versa over CAPIF-6e reference point. The CCF 2 of CAPIF provider A provides the information about the service APIs to the CCF 1 over CAPIF-6 reference point. The API invokers may exist within the trust domain of CAPIF provider A, or within the trust domain of CAPIF provider B or outside of the trust domains of both CAPIF provider A and CAPIF provider B. The API invoker of a CAPIF provider is onboarded with the CCF in the corresponding trust domain of the CAPIF provider. One or more CCFs can publish service APIs to the designated CCF over CAPIF-6 reference point and, also discover the service APIs from the designated CCF and vice versa over CAPIF-6 reference point. The API invoker within the trust domain of CAPIF provider A interacts with the CCF of the CAPIF provider A via CAPIF-1 and discovers the service APIs of both CAPIF providers, and invokes the service APIs in the trust domain of CAPIF provider A via CAPIF-2 and invokes the service APIs in the trust domain of CAPIF provider B via CAPIF-2e. The API invoker from outside the trust domain of CAPIF providers, interacts with the CCF of the CAPIF provider A via CAPIF-1e and invokes the service APIs in the trust domain of the CAPIF providers via CAPIF-2e.

### SUMMARY

Clause 31 of 3GPP TS 22.101, V18.2.0, which is incorporated herein by reference in its entirety, has provided requirements for control of traffic from User Equipment (UE)-based applications toward an associated server. When an application on a third-party server or the third-party server itself becomes congested or fails, the traffic towards that server needs to be controlled to avoid/mitigate potential issues caused by resulting unproductive use of 3GPP network resources. Some of the requirements are as follows:
The 3GPP network shall be able to control (i.e., block and/or prioritize) traffic from UEs to an application on a third-party server or the third-party server itself without affecting traffic to other applications on the third-party server or to other third-party servers.
The 3GPP network shall be able to receive a status indication from the third-party server when an application on it is experiencing congestion or failure, and when normal operation resumes. Such a status indication may be sent periodically, and/or when the status of the application changes.
The 3GPP network shall be able to detect and monitor a third-party server's operational status e.g., congestion levels, failure, and unavailability of the third-party server.

For example, in a scenario where an Internet of Things (IoT) AS serves millions of devices, when the AS's response time increases due to high traffic congestion at the AS, it is required to able to control (i.e., block and/or prioritize) the traffic from UEs or IoT devices towards the AS.

It is an object of the present disclosure to provide network nodes and methods therein for AS monitoring.

According to a first aspect of the present disclosure, a method in an AMF is provided. The method includes: transmitting, to a CCF, a registration request or registration update request containing AEF information on an AEF. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the AEF may be an AS.

According to a second aspect of the present disclosure, a method in a CCF is provided. The method includes: receiving, from an AMF, a registration request or registration update request containing AEF information on an AEF. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the AEF may be an AS.

In an embodiment, the method may further include: receiving, from an API invoker, a request for subscribing, or updating subscription, for notification of AEF information associated with the AEF or an AEF type to which the AEF belongs; and transmitting, to the API invoker, a notification of the AEF information.

In an embodiment, the request for subscribing or updating may include an event filter for an identification of the AEF or the AEF type.

According to a third aspect of the present disclosure, a method in an API invoker is provided. The method includes: transmitting, to a CCF, a request for subscribing, or updating subscription, for notification of AEF information associated with an AEF or an AEF type to which the AEF belongs; and receiving, from the CCF, a notification of the AEF information, the AEF information including a status of the AEF.

In an embodiment, the status of the AEF may indicate that the AEF is operating normally, is under maintenance, or has failed.

In an embodiment, the AEF information may further indicate one or more of: a type of the AEF, load information, capacity information, or a heartbeat configuration.

In an embodiment, the AEF may be an AS.

In an embodiment, the request for subscribing or updating may include an event filter for an identification of the AEF or the AEF type.

According to a fourth aspect of the present disclosure, a method in an APF is provided. The method includes: transmitting, to a CCF, a service API publish request or service API update request containing service API status information indicating a status of a service API.

In an embodiment, the service API status information may be used by the CCF during a service API discovery procedure.

In an embodiment, the service API status information may be carried in service API information.

In an embodiment, the status of the service API may include active or inactive.

In an embodiment, the service API may be provided by an AS as an AEF.

According to a fifth aspect of the present disclosure, a method in a CCF is provided. The method includes: receiving, from an APF, a service API publish request or service API update request containing service API status information indicating a status of a service API, and indicating, to an API invoker or another CCF, the service API status information as part of a service API discovery procedure.

In an embodiment, the service API status information may be carried in service API information.

In an embodiment, the status of the service API may include active or inactive.

In an embodiment, the service API may be provided by an AS as an AEF.

In an embodiment, the method may further include: transmitting, to another CCF, an interconnection API publish request containing the service API status information.

In an embodiment, the service API discovery procedure may further include: receiving, from an API invoker or the other CCF, a service API discover request; and transmitting, to the API invoker or the other CCF, a service API discover response based on the service API status information.

In an embodiment, the operation of transmitting the service API discover response based on the service API status information may include: transmitting the service API discover response that contains service API information of the service API, the service API information containing the service API status information.

In an embodiment, the method may further include: receiving, from the API invoker, an onboard API invoker request containing an indication that the API invoker is to take control of API invocation influence; and transmitting, to the API invoker, an onboard API invoker response containing a confirmation that the API invoker is to take control of API invocation influence. The service API discover response may be transmitted in response to the API invoker being to take control of API invocation influence.

In an embodiment, the operation of transmitting the service API discover response based on the service API status information may include: transmitting the service API discover response that contains service API information of the service API when the status of the service API is active

In an embodiment, the method may further include: receiving, from the API invoker, an onboard API invoker request containing an indication that the CCF is to take control of API invocation influence or containing no indication on whether the API invoker or the CCF is to take control of API invocation influence; and transmitting, to the API invoker, an onboard API invoker response containing a confirmation or indication that the CCF is to take control of API invocation influence. The service

API discover response may be transmitted in response to the CCF being to take control of API invocation influence.

In an embodiment, the method may further include: receiving, from an AMF, a registration request or registration update request containing AEF information on an AEF that is an AS providing the service API. The AEF information may include a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the operation of transmitting the service API discover response based on the service API status information may include: transmitting the service API discover response that contains service API information of the service API and at least one of the status of the AEF and the load information, the service API information containing the service API status information.

In an embodiment, the method may further include: receiving, from the API invoker, an onboard API invoker request containing an indication that the API invoker is to take control of API invocation influence; and transmitting, to the API invoker, an onboard API invoker response containing a confirmation that the API invoker is to take control of API invocation influence. The service API discover response may be transmitted in response to the API invoker being to take control of API invocation influence.

In an embodiment, the operation of transmitting the service API discover response based on the service API status information may include: transmitting the service API discover response that contains service API information of the service API when the status of the service API is active and when the status of the AEF indicates that the AEF is operating normally and/or the load information indicates that a load on the AEF is lower than a threshold.

In an embodiment, the method may further include: receiving, from the API invoker, an onboard API invoker request containing an indication that the CCF is to take control of API invocation influence or containing no indication on whether the API invoker or the CCF is to take control of API invocation influence; and transmitting, to the API invoker, an onboard API invoker response containing a confirmation or indication that the CCF is to take control of API invocation influence. The service

API discover response may be transmitted in response to the CCF being to take control of API invocation influence.

In an embodiment, the method may further include: receiving, from an API invoker or another CCF, a request for subscribing, or updating subscription, for notification of service API status information associated with the service API or a service API type to which the service API belongs; and transmitting, to the API invoker or the other CCF, a notification of the service API status information.

In an embodiment, the request for subscribing or updating may include an event filter for an identification of the service API or the service API type.

According to a sixth aspect of the present disclosure, a method in an API invoker is provided. The method includes: receiving, from a CCF, service API status information indicating a status of a service API as part of a service API discovery procedure.

In an embodiment, the status of the service API may include active or inactive.

In an embodiment, the service API may be provided by an AS as an AEF.

In an embodiment, the service API discovery procedure may further include: transmitting, to the CCF, a service API discover request. The operation of receiving the service API status information may include: receiving, from the CCF, a service API discover response that contains service API information of the service API, the service API information containing the service API status information.

In an embodiment, the method may further include: selecting the service API when the status of the service API is active.

In an embodiment, the method may further include: transmitting, to the CCF, a request for subscribing, or updating subscription, for notification of AEF information associated with an AEF that is an AS providing the service API or an AEF type to which the AEF belongs; and receiving, from the CCF, a notification of the AEF information. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the method may further include: selecting the service API when the status of the service API is active and when the status of the AEF indicates that the AEF is operating normally and/or the load information indicates that a load on the AEF is lower than a threshold.

In an embodiment, the request for subscribing or updating may include an event filter for an identification of the AEF or the AEF type.

In an embodiment, the method may further include: transmitting, to the CCF, a request for subscribing, or updating subscription, for notification of service API status information associated with the service API or a service API type to which the service API belongs. The operation of receiving the service API status information may include: receiving, from the CCF, a notification of the service API status information.

In an embodiment, the request for subscribing or updating may include an event filter for an identification of the service API or the service API type.

In an embodiment, the method may further include: transmitting, to the CCF, an onboard API invoker request containing an indication that the CCF is to take control of API invocation influence or containing no indication on whether the API invoker or the CCF is to take control of API invocation influence; and receiving, from the CCF, an onboard API invoker response containing a confirmation or indication that the CCF is to take control of API invocation influence.

In an embodiment, the method may further include: transmitting, to the CCF, an onboard API invoker request containing an indication that the API invoker is to take control of API invocation influence; and receiving, from the CCF, an onboard API invoker response containing a confirmation that the API invoker is to take control of API invocation influence.

According to a seventh aspect of the present disclosure, a network node is provided. The network node includes a communication interface, a processor and a memory. The memory contains instructions executable by the processor whereby the network node is operative to, when implementing an AMF, perform the method according to the above first aspect, or when implementing a CCF, perform the method according to the above second or fifth aspect, or when implementing an API invoker, perform the method according to the above third or sixth aspect, or when implementing an APF, perform the method according to the above fourth aspect.

According to an eighth aspect of the present disclosure, a computer-readable storage medium is provided. The computer-readable storage medium has computer-readable instructions stored thereon. The computer-readable instructions, when executed by a processor of a network node, configure the network node to, when implementing an AMF, perform the method according to the above first aspect, or when implementing a CCF, perform the method according to the above second or fifth aspect, or when implementing an API invoker, perform the method according to the above third or sixth aspect, or when implementing an APF, perform the method according to the above fourth aspect.

With the embodiments of the present disclosure, information on a status of an AEF, which can be an AS, and/or information on a status of a service API provided on the AEF can be provided to a CCF, which can in turn provide the information to an API invoker. In this way, the status of the AS and/or the status of the service API provided on the AS can be monitored.

### BRIEF DESCRIPTION OF THE DRAWINGS

The above and other objects, features and advantages will be more apparent from the following description of embodiments with reference to the figures, in which:

FIG. 1 is a schematic diagram showing a functional model for the CAPIF to support 3^{rd} party API providers;

FIG. 2A is a schematic diagram showing a high level functional architecture for CAPIF interconnection with multiple CAPIF provider domains;

FIG. 2B is a schematic diagram showing a high level functional architecture for CAPIF interconnection within a CAPIF provider domain;

FIG. 3 is a flowchart illustrating a method in an AMF according to an embodiment of the present disclosure;

FIG. 4A is a sequence diagram showing an exemplary procedure for registration of API provider domain functions on CAPIF according to an embodiment of the present disclosure;

FIG. 4B is a sequence diagram showing an exemplary procedure for update of registration information of API provider domain functions on CAPIF according to an embodiment of the present disclosure;

FIG. 5 is a flowchart illustrating a method in a CCF according to an embodiment of the present disclosure;

FIG. 6 is a sequence diagram showing an exemplary procedure for AEF information subscription and notification according to an embodiment of the present disclosure;

FIG. 7 is a flowchart illustrating a method in an API invoker according to an embodiment of the present disclosure;

FIG. 8 is a flowchart illustrating a method in an APF according to an embodiment of the present disclosure;

FIG. 9A is a sequence diagram showing an exemplary procedure for publishing a service API according to an embodiment of the present disclosure;

FIG. 9B is a sequence diagram showing an exemplary procedure for updating a service API according to an embodiment of the present disclosure;

FIG. 10 is a flowchart illustrating a method in a CCF according to another embodiment of the present disclosure;

FIG. 11 is a sequence diagram showing an exemplary procedure for interconnection API publish according to an embodiment of the present disclosure;

FIG. 12 is a sequence diagram showing an exemplary procedure for onboarding the API invoker to the CAPIF according to an embodiment of the present disclosure;

FIG. 13A is a sequence diagram showing an exemplary procedure for discovering a service API according to an embodiment of the present disclosure;

FIG. 13B is a sequence diagram showing an exemplary procedure for service API discovery involving multiple CCFs according to an embodiment of the present disclosure;

FIG. 13C is a sequence diagram showing an exemplary procedure for service API discovery for CAPIF interconnection according to an embodiment of the present disclosure;

FIG. 14 is a sequence diagram showing an exemplary procedure for service API status information subscription and notification according to an embodiment of the present disclosure;

FIG. 15 is a flowchart illustrating a method in an API invoker according to another embodiment of the present disclosure;

FIG. 16 is a block diagram of a network node according to an embodiment of the present disclosure; and

FIG. 17 is a block diagram of a network node according to another embodiment of the present disclosure.

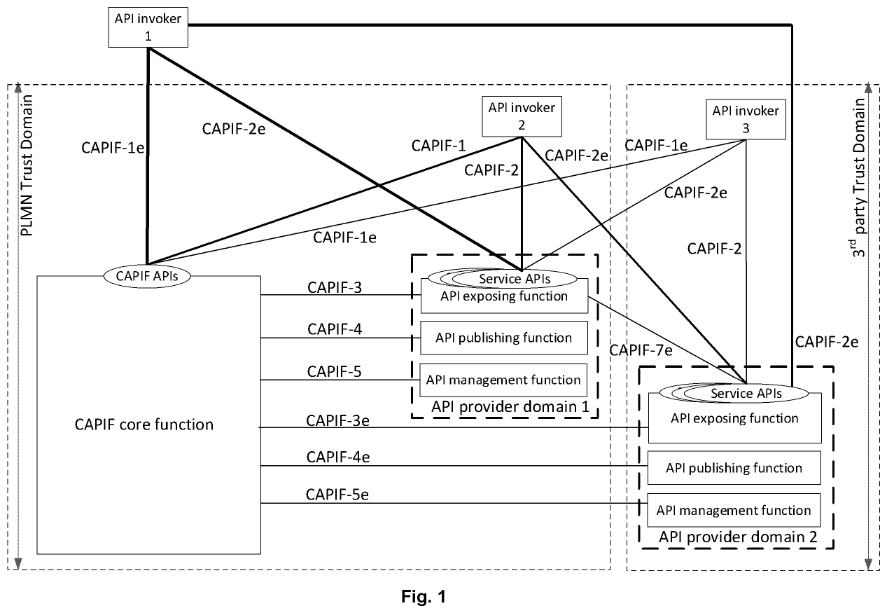

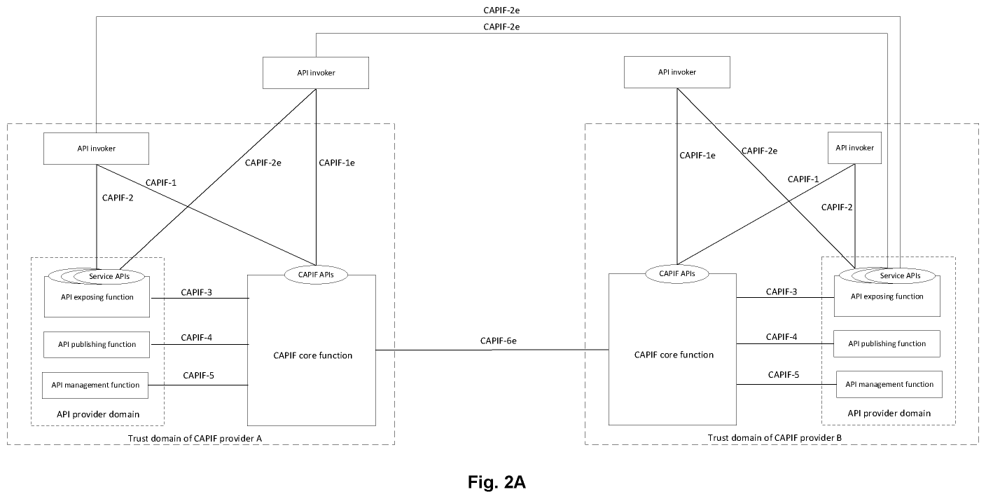

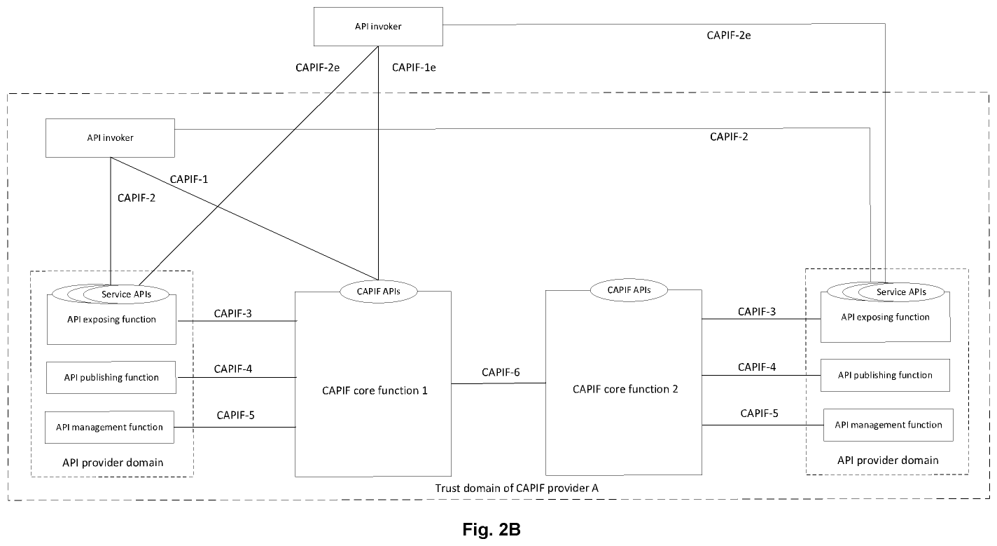

### DETAILED DESCRIPTION

In the present disclosure, a network function can be implemented either as a network element on a dedicated hardware, as a software instance running on a dedicated hardware, or as a virtualized function instantiated on an appropriate platform, e.g. on a cloud infrastructure.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

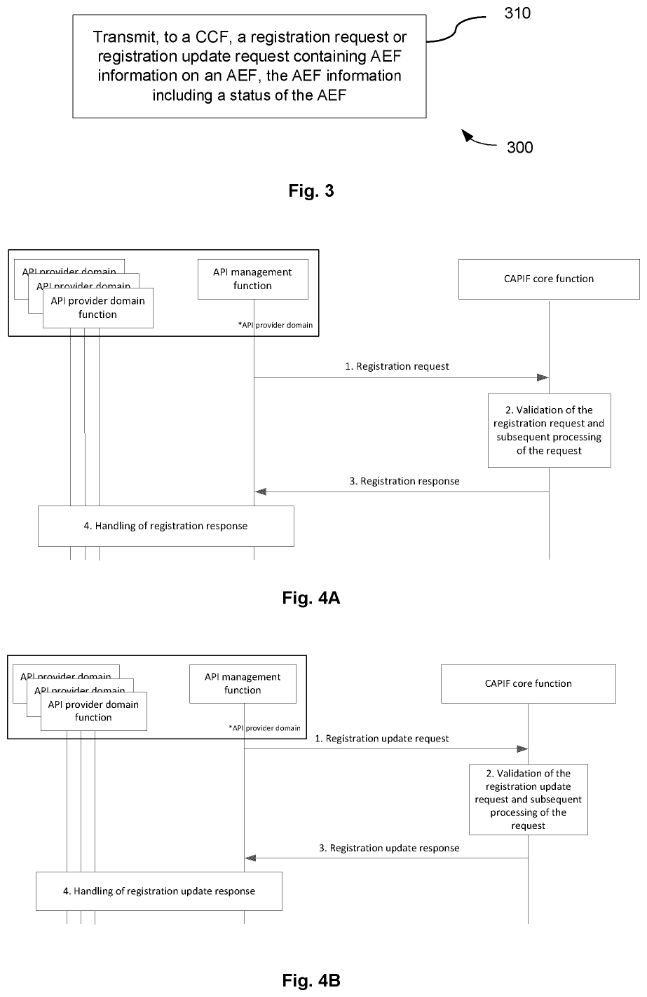

FIG. 3 is a flowchart illustrating a method 300 according to an embodiment of the present disclosure. The method 300 can be performed in an AMF.

At block 310, the AMF transmits, to a CCF, a registration request or registration update request containing AEF information on an AEF (e.g., an AS). Here, the AEF information includes a status of the AEF.

In an example, the status of the AEF may indicate that the AEF is operating normally, is under maintenance, or has failed.

In an example, the AEF information may further include one or more of:
a type of the AEF, e.g., a video transcoder,
load information, e.g., congested or non-congested,
capacity information, e.g., processing capacity of the AEF, or
a heartbeat configuration, e.g., for use by the CCF to check the availability of the AEF.

The above method 300 will be further explained below with reference to FIG. 4A, which shows an exemplary procedure for registration of API provider domain functions on CAPIF, and FIG. 4B, which shows an exemplary procedure for update of registration information of API provider domain functions on CAPIF.

As shown in FIG. 4A, at Step 1, for registration of API provider domain functions on the CCF, the AMF sends a registration request to the CCF. The registration request contains a list of information about all the API provider domain functions, which require registration on the CCF. Here, for an AS that acts as an AEF, i.e., an API provider domain function with a role of AEF, the registration request may include the AEF information as described above in connection with the method 300. The information elements in the registration request are shown in Table 1-1 below.

TABLE 1-1
Registration request

| Information element | Status | Description |
|---|---|---|
| List of API provider domain | M | List of API provider domain functions including role |
| functions | | (e.g. AEF, APF, AMF) and, if required, specific |
| | | security information. |
| >AEF information | O | The AEF information includes AEF type, AEF |
| | | status, heartbeat interval, capacity, load, load |
| | | timestamp. Applicable for API provider domain |
| | | function with AEF role. |
| Security information | M | Information for CAPIF core function to validate the |
| | | registration request |

At Step 2, the CCF validates the received request and generates the identity and other security related information for all the API provider domain functions listed in the registration request.

At Step 3, the CCF sends the generated information in the registration response message to the AMF.

At step 4, the AMF configures the received information to the individual API provider domain functions.

As shown in FIG. 4B, at Step 1, for updating the registration information of API provider domain functions on the CCF, the AMF sends a registration update request to the CCF. The registration update request contains a list of information about all the API provider domain functions, which require registration update on the CCF. Here, for an AS that acts as an AEF, i.e., an API provider domain function with a role of AEF, the registration update request may include the AEF information as described above in connection with the method 300. The information elements in the registration update request are shown in Table 1-2 below.

TABLE 1-2
Registration update request

| Information element | Status | Description |
|---|---|---|
| List of API provider domain | M | List of API provider domain functions requiring |
| functions requiring update | | updates, including role (e.g. AEF, APF, AMF) and, if |
| | | required, specific security information. |
| >AEF information | O | The AEF information includes AEF type, AEF |
| | | status, heartbeat interval, capacity, load, load |
| | | timestamp. Applicable for API provider domain |
| | | function with AEF role. |
| Security information | M | Information for CAPIF core function to validate the |
| | | registration request |

At Step 2, the CCF validates the received request and updates the identity and other security related information for all the API provider domain functions listed in the registration update request.

At Step 3, the CCF sends the updated information in the registration update response message to the API management function.

At Step 4, the AMF configures the received information to the individual API provider domain functions.

For further details of the registration and registration update procedures in FIGS. 4A and 4B, reference can be made to TS 23.222.

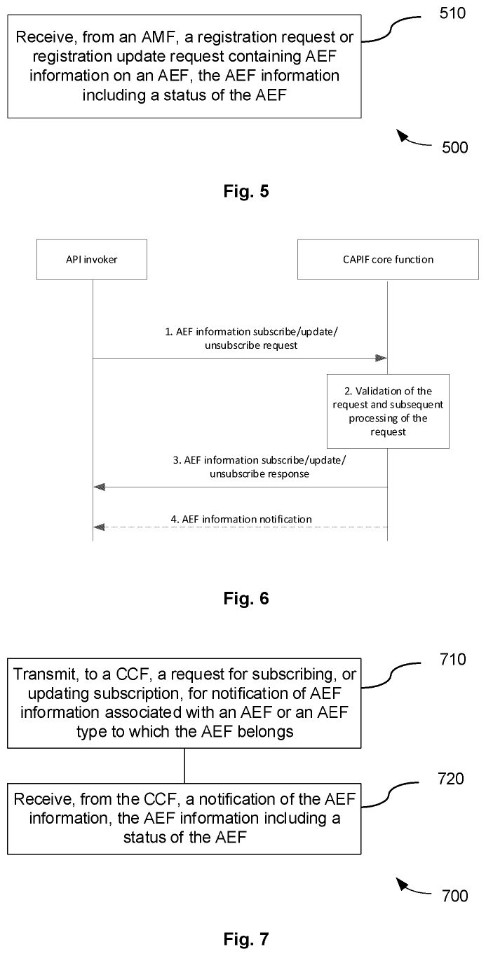

FIG. 5 is a flowchart illustrating a method 500 according to an embodiment of the present disclosure. The method 500 can be performed in a CCF.

At block 510, the CCF receives, from an AMF, a registration request or registration update request containing AEF information on an AEF (e.g., an AS). The AEF information includes a status of the AEF.

For example, the registration request or registration update request may be the registration request or registration update request as described above in connection with FIGS. 3, 4A and 4B. In an example, the status of the AEF may indicate that the AEF is operating normally, is under maintenance, or has failed. In an example, the AEF information may further include one or more of: a type of the AEF, load information, capacity information, or a heartbeat configuration.

In an example, the CCF may receive, from an API invoker, a request for subscribing, or updating subscription, for notification of AEF information associated with the AEF or an AEF type to which the AEF belongs. The request for subscribing or updating may include an event filter for an identification (ID) of the AEF or the AEF type. Then, the CCF may transmit, to the API invoker, a notification of the AEF information, e.g., when there is any change in the AEF information. For the subscription and notification, the CAPIF event exposure service defined in TS 23.222 can be reused to support a new event “AEF Info Update”, as shown in FIG. 6.

FIG. 6 shows an exemplary procedure for AEF information subscription and notification. As shown, at Step 1, the API invoker sends an AEF information subscribe (or update) request to the CCF. The request contains an event filter for the AEF ID or the AEF type. At Step 2, the CCF validates the request and performs subsequent processing of the request. At Step 3, the CCF sends an AEF information subscribe (or update) response to the API invoker. At Step 4, when there is any change in the AEF information (e.g., the AEF information may be changed either by an AMF in a registration update process or by the CCF in a heartbeat process), the CCF sends an AEF information notification to the API invoker. The API invoker may also unsubscribe the notification event from the CCF, as shown in Step 1, and the CCF may send an AEF information unsubscribe response to the API invoker, as shown in Step 3.

For further details of the CAPIF event exposure service, reference can be made to TS 23.222.

FIG. 7 is a flowchart illustrating a method 700 according to an embodiment of the present disclosure. The method 700 can be performed in an API invoker.

At block 710, the API invoker transmits, to a CCF, a request for subscribing, or updating subscription, for notification of AEF information associated with an AEF (e.g., an AS) or an AEF type to which the AEF belongs. In an example, the request for subscribing or updating may include an event filter for an identification (ID) of the AEF or the AEF type. For example, the request here may be the request (e.g., AEF information subscribe (or update) request) as described above in connection with FIGS. 5 and 6.

At block 720, the API invoker receives, from the CCF, a notification of the AEF information. The AEF information includes a status of the AEF.

In an example, the status of the AEF may indicate that the AEF is operating normally, is under maintenance, or has failed. In an example, the AEF information may further include one or more of: a type of the AEF, load information, capacity information, or a heartbeat configuration.

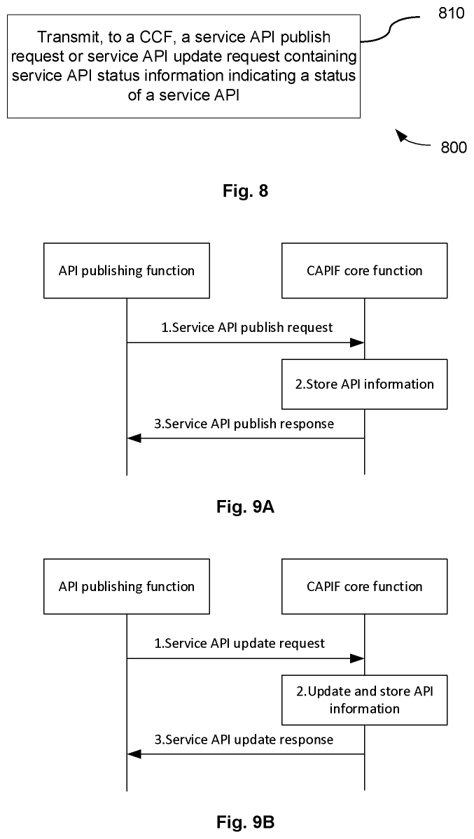

FIG. 8 is a flowchart illustrating a method 800 according to an embodiment of the present disclosure. The method 800 can be performed in an APF.

At block 810, the APF transmits, to a CCF, a service API publish request or service API update request containing service API status information indicating a status of a service API.

In an example, the service API status information may be used by the CCF during a service API discovery procedure.

In an example, the service API status information may be carried in service API information.

In an example, the status of the service API may include active or inactive.

In an example, the service API may be provided by an AS as an AEF.

The above method 800 will be further explained below with reference to FIG. 9A, which shows an exemplary procedure for publishing a service API, and FIG. 9B, which shows an exemplary procedure for updating a service API.

As shown in FIG. 9A, at Step 1, the APF sends a service API publish request to the CCF, with the details of the service API. If the service API is to be shared to other CAPIF core functions, the shareable information and the CAPIF provider domain information are included. Here, the service API publish request may include the service API status information as described above in connection with the method 800. The information elements in the service API publish request are shown in Table 2-1 below.

TABLE 2-1
Service API publish request

| Information element | Status | Description |
|---|---|---|
| API publisher information | M | The information of the API publisher may include |
| | | identity, authentication and authorization |
| | | information |
| Service API information | M | The service API information includes the service |
| | | API name, service API type, service API status (e.g. |
| | | active, inactive), communication type, description, |
| | | Serving Area Information (optional), AEF location |
| | | (optional), interface details (e.g. IP address, port |
| | | number, URI), protocols, version numbers, and |
| | | data format. |
| Shareable information | O (see NOTE) | Indicates whether the service API or the service API |
| | | category can be published to other CCFs. And if |
| | | sharing, a list of CAPIF provider domain information |
| | | where the service API or the service API category |
| | | can be published is contained. |

(NOTE):
If the shareable information is not present, the service API is not allowed to be shared.

At Step 2, upon receiving the service API publish request, the CCF checks whether the APF is authorized to publish service APIs. If the check is successful, the service API information provided by the APF is stored at the CCF (API registry).

At Step 3, the CCF provides a service API publish response to the APF indicating success or failure result and triggers notifications to subscribed API invokers.

As shown in FIG. 9B, at Step 1, the APF sends a service API update request to the CCF, which includes the service API published information reference provided by the CCF when the service API was published and the new service API information which is to be updated. Here, the service API update request may include the service API status information as described above in connection with the method 800. The information elements in the service API update request are shown in Table 2-2 below.

TABLE 2-2
Service API update request

| Information element | Status | Description |
|---|---|---|
| API publisher information | M | The information of the API publisher may include |
| | | identity, authentication and authorization |
| | | information |
| Service API published | M | The information (set) provided by the CAPIF core |
| information reference | | function about the published service API which can |
| | | be used for reference by the API publishing |
| | | function. |
| Service API information | M | The service API information includes the service |
| | | API name, service API type, service API status (e.g. |
| | | active, inactive), communication type, description, |
| | | Serving Area Information (optional), AEF location |
| | | (optional), interface details (e.g. IP address, port |
| | | number, URI), protocols, version numbers, and |
| | | data format which is required to replace the existing |
| | | service API information |
| Reason | O | The reason of the update (e.g. change log) |

At Step 2, upon receiving the service API update request, the CCF checks whether the APF is authorized to update the published service APIs information. If the check is successful, the service API information provided by the APF is updated at the CCF (API registry).

At Step 3, the CCF provides a service API update response to the APF and triggers notifications to subscribed API invokers.

For further details of the procedure for publishing a service API and the procedure for updating a service API, reference can be made to TS 23.222.

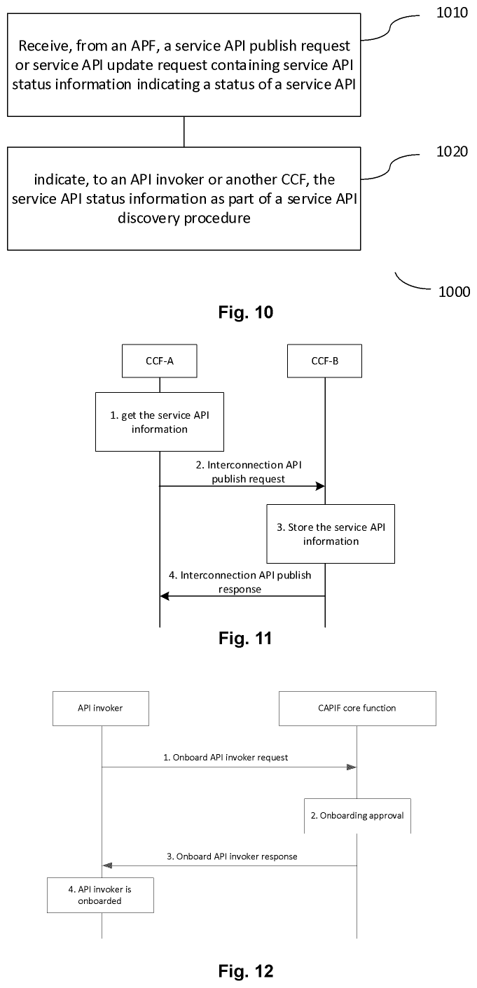

FIG. 10 is a flowchart illustrating a method 1000 according to an embodiment of the present disclosure. The method 1000 can be performed in a CCF.

At block 1010, the CCF receives, from an APF, a service API publish request or service API update request containing service API status information indicating a status of a service API.

At block 1020, the CCF indicates, to an API invoker or another CCF, the service API status information as part of a service API discovery procedure

For example, the service API publish request or service API update request may be the service API publish request or service API update request as described above in connection with FIGS. 8, 9A and 9B. In an example, the service API status information may be carried in service API information. In an example, the status of the service API may include active or inactive. In an example, the service API may be provided by an AS as an AEF.

In an example, the CCF may transmit, to another CCF, an interconnection API publish request containing the service API status information. FIG. 11 shows an exemplary procedure for interconnection API publish. As shown, at Step 1, CCF-A gets the service APIs to be shared with CCF-B from the APF which is in the same CAPIF provider domain of CCF-A, or from another CCF as described in this procedure. At Step 2, based on the shareable information for the service API or the service API category information, the CCF-A determines to publish the service API or the service API category information to the CCF-B. The CCF-A sends the interconnection API publish request to CCF-B with the details of at least one of service APIs or the category information of the service APIs, along with the identity information of CCF-A, shareable information and CAPIF provider domain information if allowed to share. Here, the interconnection API publish request may contain the service API status information, as described above. At Step 3, CCF-B stores the service API information or service API category provided by the CCF-A. At Step 4, CCF-B provides an interconnection API publish response to the CCF-A indicating success or failure result and triggers notifications to subscribed API invokers. For further details of the procedure for interconnection API publish, reference can be made to TS 23.222.

In an example, the CCF may receive, from an API invoker or the other CCF, a service API discover request, and transmit, to the API invoker or the other CCF, a service API discover response based on the service API status information.

The CCF may take control of API invocation influence, i.e., perform filtering of service APIs based on service API status information before providing service API information to the API invoker in the service API discover response. Alternatively, the CCF may not perform filtering of service APIs based on service API status information, but instead providing service API status information to the API invoker in the service API discover response such that the API invoker can take control of API invocation influence, i.e., select or invoke a service API properly based on the service API status information. The CCF and the API invoker may negotiate to decide which one of them is to take control of API invocation influence, referring to FIG. 12.

FIG. 12 shows an exemplary procedure for onboarding the API invoker to the CAPIF. As shown, at Step 1, for enrollment of the API invoker to be a recognized user of the CAPIF, the API invoker triggers onboard API invoker request towards the CCF, providing the information as required for the API management. Here, the onboard API invoker request may contain an indication on whether the CCF or the API invoker is to take control of API invocation influence. The information elements in the onboard API invoker request are shown in Table 3-1 below.

TABLE 3-1
Onboard API invoker request

| Information element | Status | Description |
|---|---|---|
| Onboarding information | M | The information of the API invoker including |
| | | enrolment details, required for onboarding |
| APIs for enrollment | O | List of APIs being enrolled for. |
| API invocation influence control | O | Indicate whether API invoker takes the control for |
| information | | API invocation influence considering AS status. |

At Step 2, the CCF begins the onboarding process by verifying whether all the necessary information has been provided to onboard the API invoker, and further initiates a grant process. Successful onboarding results in provisioning API invoker profile which includes identity for the API invoker. The authorization information and the list of APIs and the types of APIs that the API invoker can access subsequent to successful onboarding may also be created.

At Step 3, if the API invoker has triggered the onboard API invoker request and is granted permission, the onboard API invoker response provides success indication including information from the provisioned API invoker profile which may include information to allow the API invoker to be authenticated and to obtain authorization for service APIs. Here, if the onboard API invoker request contains an indication on whether the CCF or the API invoker is to take control of API invocation influence, the CCF may follow the indication and include in the onboard API invoker response a confirmation that the CCF or the API invoker is to take control of API invocation influence. If the onboard API invoker request contains no indication on whether the CCF or the API invoker is to take control of API invocation influence, the CCF may take control of API invocation influence and include in the onboard API invoker response an indication that the CCF is to take control of API invocation influence. The information elements in the onboard API invoker request are shown in Table 3-2 below.

TABLE 3-2
Onboard API invoker response

| Information element | Status | Description |
|---|---|---|
| Onboarding status | M | The result of onboarding request i.e., success |
| | | indication is included if the API invoker is granted |
| | | permission otherwise failure. |
| Enrolled information | O | Information from the provisioned API invoker profile |
| | (see NOTE 1) | which may include information to allow the API |
| | | invoker to be authenticated and to obtain |
| | | authorization for service APIs |
| Service API information | O | The service API information includes the service |
| | (see NOTE 2) | API name, service API type, communication type, |
| | | description, Serving Area Information (optional), |
| | | AEF location (optional), interface details (e.g. IP |
| | | address, port number, URI), protocols, version |
| | | numbers, and data format. |
| API invocation influence control | O (NOTE 2) | Indicate whether CAPIF and which CAPIF entity |
| information | | (i.e. API invoker or CCF) take the control for API |
| | | invocation influence considering AS status. |
| Reason | O | This element indicates the reason when onboarding |
| | (see NOTE 3) | status is failure. |

(NOTE 1):
Information element shall be present when onboarding status is successful.
(NOTE 2):
Information element may be present when onboarding status is successful.
(NOTE 3):
Information element shall be present when onboarding status is failure.

At Step 4, as a result of successful onboarding process, the CCF is able to authenticate and authorize the API invoker.

In particular, in an example, the CCF may receive, from the API invoker, an onboard API invoker request containing an indication that the API invoker is to take control of API invocation influence, and transmit, to the API invoker, an onboard API invoker response containing a confirmation that the API invoker is to take control of API invocation influence. In this case, in response to the API invoker being to take control of API invocation influence, the CCF may transmit the service API discover response that contains service API information of the service API, and the service API information may contain the service API status information. Alternatively, the CCF may receive, from the API invoker, an onboard API invoker request containing an indication that the CCF is to take control of API invocation influence or containing no indication on whether the API invoker or the CCF is to take control of API invocation influence, and transmit, to the API invoker, an onboard API invoker response containing a confirmation or indication that the CCF is to take control of API invocation influence. In this case, in response to the CCF being to take control of API invocation influence, the CCF may transmit the service API discover response that contains service API information of the service API when the status of the service API is active.

In addition, as described above in connection with the method 500, the CCF may further receive, from an AMF, a registration request or registration update request containing AEF information on an AEF that is an AS providing the service API. The AEF information may include a status of the AEF. Here, the status of the AEF may indicate that the AEF is operating normally, is under maintenance, or has failed. The AEF information may further include one or more of: a type of the AEF, load information, capacity information, or a heartbeat configuration.

The CCF may take control of API invocation influence, i.e., perform filtering of service APIs based on service API status information and AEF information before providing service API information to the API invoker in the service API discover response. Alternatively, the CCF may not perform filtering of service APIs based on service API status information, but instead providing service API status information and AEF information to the API invoker in the service API discover response such that the API invoker can take control of API invocation influence, i.e., select or invoke a service API properly based on the service API status information and the AEF information. The CCF and the API invoker may negotiate to decide which one of them is to take control of API invocation influence, as described above with reference to FIG. 12.

In particular, in an example, the CCF may receive, from the API invoker, an onboard API invoker request containing an indication that the API invoker is to take control of API invocation influence, and transmit, to the API invoker, an onboard API invoker response containing a confirmation that the API invoker is to take control of API invocation influence. In this case, in response to the API invoker being to take control of API invocation influence, the CCF may transmit, to the API invoker or the other CCF, the service API discover response that contains service API information of the service API (containing the service API status information) and at least one of the status of the AEF and the load information. Alternatively, the CCF may receive, from the API invoker, an onboard API invoker request containing an indication that the CCF is to take control of API invocation influence or containing no indication on whether the API invoker or the CCF is to take control of API invocation influence, and transmit, to the API invoker, an onboard API invoker response containing a confirmation or indication that the CCF is to take control of API invocation influence. In this case, in response to the CCF being to take control of API invocation influence, the CCF may transmit, to the API invoker or the other CCF, the service API discover response that contains service API information of the service API when the status of the service API is active and when the status of the AEF indicates that the AEF is operating normally and/or the load information indicates that a load on the AEF is lower than a threshold.

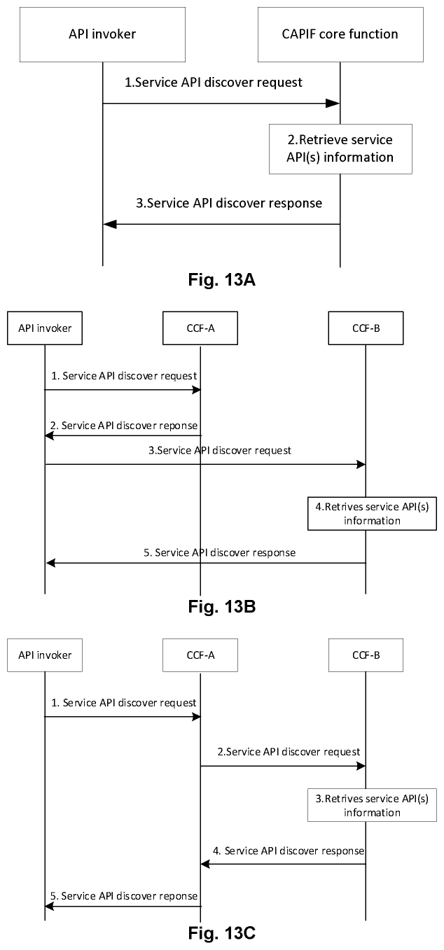

The procedure for service API discovery will be further explained below with reference to FIG. 13A, which shows an exemplary procedure for discovering a service API, FIG. 13B, which shows an exemplary procedure for service API discovery involving multiple CCFs, and FIG. 13C, which shows an exemplary procedure for service API discovery for CAPIF interconnection.

As shown in FIG. 13A, at Step 1, the API invoker sends a service API discover request to the CCF. It includes the API invoker identity, and may include query information. At Step 2, upon receiving the service API discover request, the CCF verifies the identity of the API invoker (via authentication). The CCF retrieves the stored service API(s) information from the CCF (API registry) as per the query information in the service API discover request. Further, the CCF applies the discovery policy and performs filtering of service APIs information retrieved from the CCF. At Step 3, the CCF sends a service API discover response to the API invoker with the list of service API information for which the API invoker has the required authorization. Here, optionally, in Step 2, the CCF may perform filtering of the service API information based on the service API status information and/or the AEF information. For example, the CCF may filter out service API information of a particular service API when it is in the inactive status and/or when its AEF (AS) is under maintenance or has failed and/or the load on its AEF (AS) is higher than or equal to a threshold. Accordingly, in Step 3, the CCF may send to the API invoker the service API discover response containing the list of service API information of only service APIs each being active and/or having its AEF (AS) operating normally and/or having the load on its AEF (AS) lower than the threshold. Alternatively, if the CCF does not perform such filtering in Step 2, then in Step 3, the CCF may send to the API invoker the service API discover response containing the list of service API information, and the service API information contains the service API status information such that the API invoker can determine whether to select a particular service API or not based on its corresponding service API status information.

As shown in FIG. 13B, at Step 1, the API invoker sends a service API discover request to CCF-A. It includes the API invoker identity, and may include query information. At Step 2, the CCF-A verifies the identity of the API invoker and retrieves the stored service API(s) information and service API categories. The information of CCF-B with the service API category matching the discovery criteria is returned to API invoker in the service API discover response. At step 3, the API invoker sends a service API discover request to CCF-B. The identity of API invoker is included. The query information is also provided. At Step 4, upon receiving the service API discover request, CCF-B verifies the identity of the API invoker. The CCF-B retrieves the stored service API(s) information as per the query information in the service API discover request. Further, the CCF-B applies the discovery policy and performs filtering of service APIs information which matches the discovery criteria. At Step 5, CCF-B sends a service API discover response to the API invoker with the list of service API information for which the API invoker has the required authorization. Here, optionally, in Step 4, CCF-B may perform filtering of the service API information based on the service API status information and/or the AEF information. For example, CCF-B may filter out service API information of a particular service API when it is in the inactive status and/or when its AEF (AS) is under maintenance or has failed and/or the load on its AEF (AS) is higher than or equal to a threshold. Accordingly, in Step 5, CCF-B may send to the API invoker the service API discover response containing the list of service API information of only service APIs each being active and/or having its AEF (AS) operating normally and/or having the load on its AEF (AS) lower than the threshold. Alternatively, if CCF-B does not perform such filtering in Step 4, then in Step 5, CCF-B may send to the API invoker the service API discover response containing the list of service API information, and the service API information contains the service API status information such that the API invoker can determine whether to select a particular service API or not based on its corresponding service API status information.

As shown in FIG. 13C, at Step 1, the API invoker sends a service API discover request to CCF-A. It includes the API invoker identity, and may include query information. CCF-A is triggered to perform service API discovery with the CCF-B. At Step 2, CCF-A sends the (interconnection) service API discover request to CCF-B. The identity of CCF-A and the query information are included. At Step 3, CCF-B upon receiving the (interconnection) service API discover request verifies the identity of CCF-A. CCF-B retrieves the stored service API(s) or the CCF(s) information as per the query information in the interconnection service API discover request. Further, CCF-B applies the discovery policy and performs the filtering of service APIs or the CCF(s) information. At Step 4, CCF-B sends the (interconnection) service API discover response to CCF-A with the list of service API information for which CCF-A has the required authorization or the CCF(s) information that matches the discovery criteria. At Step 5, CCF-A sends a service API discover response to the API invoker with the list of service API information for which the API invoker has the required authorization. Here, optionally, in Step 3, CCF-B may perform filtering of the service API information based on the service API status information and/or the AEF information. For example, CCF-B may filter out service API information of a particular service API when it is in the inactive status and/or when its AEF (AS) is under maintenance or has failed and/or the load on its AEF (AS) is higher than or equal to a threshold. Accordingly, in Step 4, CCF-B may send to CCF-A the service API discover response containing the list of service API information of only service APIs each being active and/or having its AEF (AS) operating normally and/or having the load on its AEF (AS) lower than the threshold. Alternatively, if CCF-B does not perform such filtering in Step 3, then in Step 4, CCF-B may send to CCF-A the service API discover response containing the list of service API information, and the service API information contains the service API status information. Similarly, CCF-A may optionally perform filtering of the list of service API information received from CCF-B based on the service API status information and/or the AEF information.

By performing such filtering based on the service API status information and/or the AEF information at the CCF or enabling the API invoker to select a service API based on the service API status information and/or the AEF information, it is possible to control traffic to/from a 3^{rd} party AS properly when it is experiencing congestion or failure or when it resumes normal operation.

For further details of the procedures for service API discovery, reference can be made to TS 23.222.

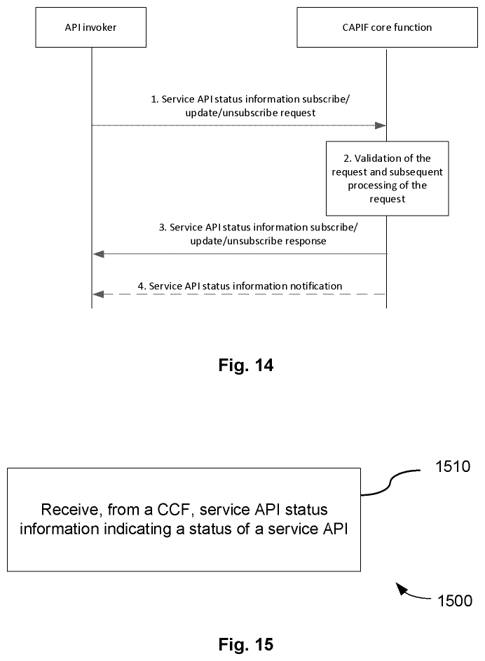

In another example, the CCF may receive, from an API invoker or another CCF, a request for subscribing, or updating subscription, for notification of service API status information associated with the service API or a service API type to which the service API belongs. Here, the request for subscribing or updating may include an event filter for an identification (ID) of the service API or the service API type. Then, the CCF may transmit, to the API invoker or the other CCF, a notification of the service API status information, e.g., when there is any change in the service API status information. For the subscription and notification, the CAPIF event exposure service defined in TS 23.222 can be reused to support a new event “Service API Status Info Update”, as shown in FIG. 14.

FIG. 14 shows an exemplary procedure for service API status information subscription and notification. As shown, at Step 1, the API invoker sends a service API status information subscribe (or update) request to the CCF. The request contains an event filter for the service API ID or the service API type. At Step 2, the CCF validates the request and performs subsequent processing of the request. At Step 3, the CCF sends a service API status information subscribe (or update) response to the API invoker. At Step 4, when there is any change in the service API status information (e.g., the service API status information may be changed either by an APF in a registration update process or by the CCF probing the service API status), the CCF sends a service API status information notification to the API invoker. The API invoker may also unsubscribe the notification event from the CCF, as shown in Step 1, and the CCF may send a service API status information unsubscribe response to the API invoker, as shown in Step 3.

For further details of the CAPIF event exposure service, reference can be made to TS 23.222.

FIG. 15 is a flowchart illustrating a method 1400 according to an embodiment of the present disclosure. The method 1400 can be performed in an API invoker.

At block 1510, the API invoker receives, from a CCF, service API status information indicating a status of a service API as part of a service API discovery procedure.

In an example, the status of the service API may include active or inactive. In an example, the service API may be provided by an AS as an AEF.

In an example, the API invoker may transmit, to the CCF, a service API discover request, and then receive, from the CCF, a service API discover response that contains service API information of the service API. The service API information contains the service API status information. For further details, reference can be made to FIGS. 13A-13C, and description thereof will be omitted here.

In an example, the API invoker may select the service API when the status of the service API is active.

In addition, the API invoker may transmit, to the CCF, a request for subscribing, or updating subscription, for notification of AEF information associated with an AEF that is an AS providing the service API or an AEF type to which the AEF belongs. Here, the request for subscribing or updating may include an event filter for an identification (ID) of the AEF or the AEF type. Then, the API invoker may receive, from the CCF, a notification of the AEF information. The AEF information may include status of the AEF. For example, the status of the AEF may indicate that the AEF is operating normally, is under maintenance, or has failed. Moreover, the AEF information may further include one or more of: a type of the AEF, load information, capacity information, or a heartbeat configuration. In this case, the API invoker may select the service API when the status of the service API is active and when the status of the AEF indicates that the AEF is operating normally and/or the load information indicates that a load on the AEF is lower than a threshold. For further details, reference can be made to FIG. 6, and description thereof will be omitted here.

In another example, the API invoker may transmit, to the CCF, a request for subscribing, or updating subscription, for notification of service API status information associated with the service API or a service API type to which the service API belongs. Here, the request for subscribing or updating may include an event filter for an identification (ID) of the service API or the service API type. Then, the API invoker may receive, from the CCF, a notification of the service API status information. For further details, reference can be made to FIG. 14, and description thereof will be omitted here.

In an example, the API invoker may transmit, to the CCF, an onboard API invoker request containing an indication that the CCF is to take control of API invocation influence or containing no indication on whether the API invoker or the CCF is to take control of API invocation influence, and receive, from the CCF, an onboard API invoker response containing a confirmation or indication that the CCF is to take control of API invocation influence. Alternatively, the API invoker may transmit, to the CCF, an onboard API invoker request containing an indication that the API invoker is to take control of API invocation influence; and receive, from the CCF, an onboard API invoker response containing a confirmation that the API invoker is to take control of API invocation influence. For further details, reference can be made to FIG. 12, and description thereof will be omitted here.

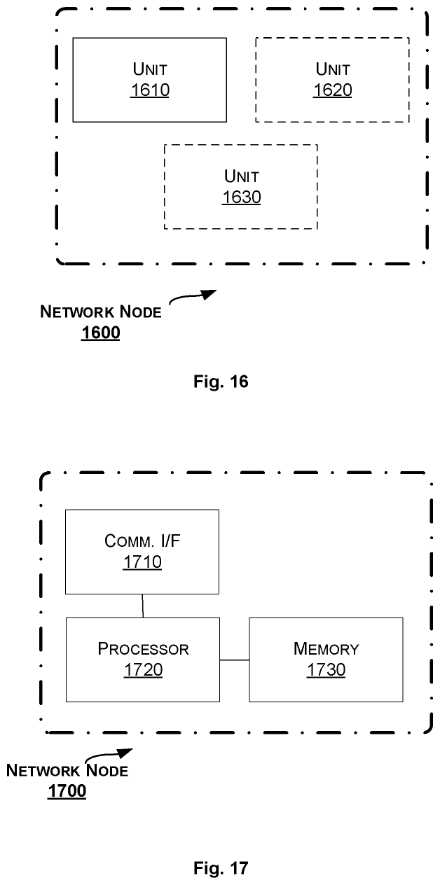

Correspondingly to the methods as described above, a network node is also provided. FIG. 16 is a block diagram of a network node 1600 according to an embodiment of the present disclosure.

The network node 1600 can be configured to implement an AMF and can be operative to perform the method 300 as described above in connection with FIG. 3. The network node 1600 includes a unit (e.g., transmitting unit) 1610 configured to transmit, to a CCF, a registration request or registration update request containing AEF information on an AEF. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the AEF may be an AS.

Alternatively, the network node 1600 can be configured to implement a CCF and can be operative to perform the method 500 as described above in connection with FIG. 5. The network node 1600 includes a unit (e.g., receiving unit) 1610 configured to receive, from an AMF, a registration request or registration update request containing AEF information on an AEF. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the AEF may be an AS.

In an embodiment, the unit 1610 may be further configured to receive, from an API invoker, a request for subscribing, or updating subscription, for notification of AEF information associated with the AEF or an AEF type to which the AEF belongs. The network node 1600 may further include a unit (e.g., transmitting unit) 1620 configured to transmit, to the API invoker, a notification of the AEF information.

In an embodiment, the request for subscribing or updating may include an event filter for an identification of the AEF or the AEF type.

Alternatively, the network node 1600 can be configured to implement an API invoker and can be operative to perform the method 700 as described above in connection with FIG. 7. The network node 1600 includes a unit (e.g., transmitting unit) 1610 configured to transmit, to a CCF, a request for subscribing, or updating subscription, for notification of AEF information associated with an AEF or an AEF type to which the AEF belongs. The network node 1600 further includes a unit (e.g., receiving unit) 1620 configured to receiving, from the CCF, a notification of the AEF information, the AEF information including a status of the AEF.

In an embodiment, the status of the AEF may indicate that the AEF is operating normally, is under maintenance, or has failed.

In an embodiment, the AEF information may further indicate one or more of: a type of the AEF, load information, capacity information, or a heartbeat configuration.

In an embodiment, the AEF may be an AS.

In an embodiment, the request for subscribing or updating may include an event filter for an identification of the AEF or the AEF type.

Alternatively, the network node 1600 can be configured to implement an APF and can be operative to perform the method 800 as described above in connection with FIG. 8. The network node 1600 includes a unit (e.g., transmitting unit) 1610 configured to transmit, to a CCF, a service API publish request or service API update request containing service API status information indicating a status of a service API.

In an embodiment, the service API status information may be used by the CCF during a service API discovery procedure.

In an embodiment, the service API status information may be carried in service API information.

In an embodiment, the status of the service API may include active or inactive.

In an embodiment, the service API may be provided by an AS as an AEF.

Alternatively, the network node 1600 can be configured to implement a CCF and can be operative to perform the method 1000 as described above in connection with FIG. 10. The network node 1600 includes a unit (e.g., receiving unit) 1610 configured to receive, from an APF, a service API publish request or service API update request containing service API status information indicating a status of a service API. The network node 1600 further includes a unit (e.g., indicating unit) 1620 configured to indicate, to an API invoker or another CCF, the service API status information as part of a service API discovery procedure

In an embodiment, the service API status information may be carried in service API information.

In an embodiment, the status of the service API may include active or inactive.

In an embodiment, the service API may be provided by an AS as an AEF.

In an embodiment, the network node 1600 may further include a unit (e.g., transmitting unit) 1630 configured to transmit, to another CCF, an interconnection API publish request containing the service API status information.

In an embodiment, the unit 1610 may be further configured to receive, from an API invoker or the other CCF, a service API discover request, and the unit 1630 may be further configured to transmit, to the API invoker or the other CCF, a service API discover response based on the service API status information.

In an embodiment, the unit 1630 may be configured to transmit the service API discover response that contains service API information of the service API, the service API information containing the service API status information.

In an embodiment, the unit 1610 may be further configured to receive, from the API invoker, an onboard API invoker request containing an indication that the API invoker is to take control of API invocation influence, and the unit 1630 may be further configured to transmit, to the API invoker, an onboard API invoker response containing a confirmation that the API invoker is to take control of API invocation influence. The service API discover response may be transmitted in response to the API invoker being to take control of API invocation influence.

In an embodiment, the unit 1630 may be configured to transmit the service API discover response that contains service API information of the service API when the status of the service API is active

In an embodiment, the unit 1610 may be further configured to receive, from the API invoker, an onboard API invoker request containing an indication that the CCF is to take control of API invocation influence or containing no indication on whether the API invoker or the CCF is to take control of API invocation influence; and the unit 1630 may be further configured to transmit, to the API invoker, an onboard API invoker response containing a confirmation or indication that the CCF is to take control of API invocation influence. The service API discover response may be transmitted in response to the CCF being to take control of API invocation influence.

In an embodiment, the unit 1610 may be further configured to receive, from an AMF, a registration request or registration update request containing AEF information on an AEF that is an AS providing the service API. The AEF information may include a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the unit 1630 may be configured to transmit the service API discover response that contains service API information of the service API and at least one of the status of the AEF and the load information, the service API information containing the service API status information.

In an embodiment, the unit 1610 may be further configured to receive, from the API invoker, an onboard API invoker request containing an indication that the API invoker is to take control of API invocation influence, and the unit 1630 may be further configured to transmit, to the API invoker, an onboard API invoker response containing a confirmation that the API invoker is to take control of API invocation influence. The service API discover response may be transmitted in response to the API invoker being to take control of API invocation influence.

In an embodiment, the unit 1630 may be configured to transmit the service API discover response that contains service API information of the service API when the status of the service API is active and when the status of the AEF indicates that the AEF is operating normally and/or the load information indicates that a load on the AEF is lower than a threshold.

In an embodiment, the unit 1610 may be further configured to receive, from the API invoker, an onboard API invoker request containing an indication that the CCF is to take control of API invocation influence or containing no indication on whether the API invoker or the CCF is to take control of API invocation influence, and the unit 1630 may be further configured to transmit, to the API invoker, an onboard API invoker response containing a confirmation or indication that the CCF is to take control of API invocation influence. The service API discover response may be transmitted in response to the CCF being to take control of API invocation influence.

In an embodiment, the unit 1610 may be further configured to receive, from an API invoker or another CCF, a request for subscribing, or updating subscription, for notification of service API status information associated with the service API or a service API type to which the service API belongs, and the unit 1630 may be further configured to, to the API invoker or the other CCF, a notification of the service API status information.

In an embodiment, the request for subscribing or updating may include an event filter for an identification of the service API or the service API type.

Alternatively, the network node 1600 can be configured to implement an API invoker and can be operative to perform the method 1500 as described above in connection with FIG. 15. The network node 1600 includes a unit (e.g., receiving unit) 1610 configured to receive, from a CCF, service API status information indicating a status of a service API as part of a service API discovery procedure.

In an embodiment, the status of the service API may include active or inactive.

In an embodiment, the service API may be provided by an AS as an AEF.

In an embodiment, the network node 1600 may further include a unit (e.g., transmitting unit) 1620 configured to transmit, to the CCF, a service API discover request. The unit 1610 may be configured to receive, from the CCF, a service API discover response that contains service API information of the service API, the service API information containing the service API status information.

In an embodiment, the network node 1600 may further include a selecting unit configured to select the service API when the status of the service API is active.

In an embodiment, the unit 1620 may be further configured to transmit, to the CCF, a request for subscribing, or updating subscription, for notification of AEF information associated with an AEF that is an AS providing the service API or an AEF type to which the AEF belongs, and the unit 1610 may be further configured to receive, from the CCF, a notification of the AEF information. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the network node 1600 may further include a selecting unit configured to select the service API when the status of the service API is active and when the status of the AEF indicates that the AEF is operating normally and/or the load information indicates that a load on the AEF is lower than a threshold.

In an embodiment, the request for subscribing or updating may include an event filter for an identification of the AEF or the AEF type.

In an embodiment, the unit 1620 may be further configured to transmit, to the CCF, a request for subscribing, or updating subscription, for notification of service API status information associated with the service API or a service API type to which the service API belongs. The unit 1610 may be configured to receive, from the CCF, a notification of the service API status information.

In an embodiment, the request for subscribing or updating may include an event filter for an identification of the service API or the service API type.

In an embodiment, the unit 1620 may be further configured to transmit, to the CCF, an onboard API invoker request containing an indication that the CCF is to take control of API invocation influence or containing no indication on whether the API invoker or the CCF is to take control of API invocation influence, and the unit 1610 may be further configured to receive, from the CCF, an onboard API invoker response containing a confirmation or indication that the CCF is to take control of

API invocation influence.

In an embodiment, the unit 1620 may be further configured to transmit, to the CCF, an onboard API invoker request containing an indication that the API invoker is to take control of API invocation influence, and the unit 1610 may be further configured to receive, from the CCF, an onboard API invoker response containing a confirmation that the API invoker is to take control of API invocation influence.

The unit 1610 (and optionally the units 1620, 1630, and one or more other units) can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIGS. 3, 5, 7, 8, 10, and 15.

FIG. 17 is a block diagram of a network node 1700 according to another embodiment of the present disclosure.

The network node 1700 includes a communication interface 1710, a processor 1720 and a memory 1730.

The memory 1730 may contain instructions executable by the processor 1720 whereby the network node 1700 is operative to, when implementing an AMF, perform the actions, e.g., of the procedure described earlier in conjunction with FIG. 3. Particularly, the memory 1730 may contain instructions executable by the processor 1720 whereby the network node 1700 is operative to, when implementing an AMF: transmit, to a CCF, a registration request or registration update request containing AEF information on an AEF. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the AEF may be an AS.

Alternatively, the memory 1730 may contain instructions executable by the processor 1720 whereby the network node 1700 is operative to, when implementing a CCF, perform the actions, e.g., of the procedure described earlier in conjunction with FIG. 5. Particularly, the memory 1730 may contain instructions executable by the processor 1720 whereby the network node 1700 is operative to, when implementing a CCF: receive, from an AMF, a registration request or registration update request containing AEF information on an AEF. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the AEF may be an AS.

In an embodiment, the memory 1730 may further contain instructions executable by the processor 1720 whereby the network node 1700 is operative to: receive, from an API invoker, a request for subscribing, or updating subscription, for notification of AEF information associated with the AEF or an AEF type to which the AEF belongs; and transmit, to the API invoker, a notification of the AEF information.

In an embodiment, the request for subscribing or updating may include an event filter for an identification of the AEF or the AEF type.

Alternatively, the memory 1730 may contain instructions executable by the processor 1720 whereby the network node 1700 is operative to, when implementing an API invoker, perform the actions, e.g., of the procedure described earlier in conjunction with FIG. 7. Particularly, the memory 1730 may contain instructions executable by the processor 1720 whereby the network node 1700 is operative to, when implementing an API invoker: transmit, to a CCF, a request for subscribing, or updating subscription, for notification of AEF information associated with an AEF or an AEF type to which the AEF belongs; and receive, from the CCF, a notification of the AEF information, the AEF information including a status of the AEF.

In an embodiment, the status of the AEF may indicate that the AEF is operating normally, is under maintenance, or has failed.

In an embodiment, the AEF information may further indicate one or more of: a type of the AEF, load information, capacity information, or a heartbeat configuration.

In an embodiment, the AEF may be an AS.

In an embodiment, the request for subscribing or updating may include an event filter for an identification of the AEF or the AEF type.

Alternatively, the memory 1730 may contain instructions executable by the processor 1720 whereby the network node 1700 is operative to, when implementing an APF, perform the actions, e.g., of the procedure described earlier in conjunction with FIG. 8. Particularly, the memory 1730 may contain instructions executable by the processor 1720 whereby the network node 1700 is operative to, when implementing an APF: transmit, to a CCF, a service API publish request or service API update request containing service API status information indicating a status of a service API.

In an embodiment, the service API status information may be used by the CCF during a service API discovery procedure.

In an embodiment, the service API status information may be carried in service API information.

In an embodiment, the status of the service API may include active or inactive.

In an embodiment, the service API may be provided by an AS as an AEF.

Alternatively, the memory 1730 may contain instructions executable by the processor 1720 whereby the network node 1700 is operative to, when implementing a CCF, perform the actions, e.g., of the procedure described earlier in conjunction with FIG. 10. Particularly, the memory 1730 may contain instructions executable by the processor 1720 whereby the network node 1700 is operative to, when implementing a CCF: receive, from an APF, a service API publish request or service API update request containing service API status information indicating a status of a service API, and indicate, to an API invoker or another CCF, the service API status information as part of a service API discovery procedure.

In an embodiment, the service API status information may be carried in service API information.

In an embodiment, the status of the service API may include active or inactive.

In an embodiment, the service API may be provided by an AS as an AEF.

In an embodiment, the memory 1730 may further contain instructions executable by the processor 1720 whereby the network node 1700 is operative to: transmit, to another CCF, an interconnection API publish request containing the service API status information.

In an embodiment, the memory 1730 may further contain instructions executable by the processor 1720 whereby the network node 1700 is operative to: receive, from an API invoker or the other CCF, a service API discover request; and transmit, to the API invoker or the other CCF, a service API discover response based on the service API status information.

In an embodiment, the operation of transmitting the service API discover response based on the service API status information may include: transmitting the service API discover response that contains service API information of the service API, the service API information containing the service API status information.

In an embodiment, the memory 1730 may further contain instructions executable by the processor 1720 whereby the network node 1700 is operative to: receive, from the API invoker, an onboard API invoker request containing an indication that the API invoker is to take control of API invocation influence; and transmit, to the API invoker, an onboard API invoker response containing a confirmation that the API invoker is to take control of API invocation influence. The service API discover response may be transmitted in response to the API invoker being to take control of API invocation influence.

In an embodiment, the operation of transmitting the service API discover response based on the service API status information may include: transmitting the service API discover response that contains service API information of the service API when the status of the service API is active

In an embodiment, the memory 1730 may further contain instructions executable by the processor 1720 whereby the network node 1700 is operative to: receive, from the API invoker, an onboard API invoker request containing an indication that the CCF is to take control of API invocation influence or containing no indication on whether the API invoker or the CCF is to take control of API invocation influence; and transmit, to the API invoker, an onboard API invoker response containing a confirmation or indication that the CCF is to take control of API invocation influence. The service API discover response may be transmitted in response to the CCF being to take control of API invocation influence.

In an embodiment, the memory 1730 may further contain instructions executable by the processor 1720 whereby the network node 1700 is operative to: receive, from an AMF, a registration request or registration update request containing AEF information on an AEF that is an AS providing the service API. The AEF information may include a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the operation of transmitting the service API discover response based on the service API status information may include: transmitting the service API discover response that contains service API information of the service API and at least one of the status of the AEF and the load information, the service API information containing the service API status information.

In an embodiment, the memory 1730 may further contain instructions executable by the processor 1720 whereby the network node 1700 is operative to: receive, from the API invoker, an onboard API invoker request containing an indication that the API invoker is to take control of API invocation influence; and transmit, to the API invoker, an onboard API invoker response containing a confirmation that the API invoker is to take control of API invocation influence. The service API discover response may be transmitted in response to the API invoker being to take control of API invocation influence.

In an embodiment, the operation of transmitting the service API discover response based on the service API status information may include: transmitting the service API discover response that contains service API information of the service API when the status of the service API is active and when the status of the AEF indicates that the AEF is operating normally and/or the load information indicates that a load on the AEF is lower than a threshold.

In an embodiment, the memory 1730 may further contain instructions executable by the processor 1720 whereby the network node 1700 is operative to: receive, from the API invoker, an onboard API invoker request containing an indication that the CCF is to take control of API invocation influence or containing no indication on whether the API invoker or the CCF is to take control of API invocation influence; and transmit, to the API invoker, an onboard API invoker response containing a confirmation or indication that the CCF is to take control of API invocation influence. The service API discover response may be transmitted in response to the CCF being to take control of API invocation influence.

In an embodiment, the memory 1730 may further contain instructions executable by the processor 1720 whereby the network node 1700 is operative to: receive, from an API invoker or another CCF, a request for subscribing, or updating subscription, for notification of service API status information associated with the service API or a service API type to which the service API belongs; and transmit, to the API invoker or the other CCF, a notification of the service API status information.

In an embodiment, the request for subscribing or updating may include an event filter for an identification of the service API or the service API type.

Alternatively, the memory 1730 may contain instructions executable by the processor 1720 whereby the network node 1700 is operative to, when implementing an API invoker, perform the actions, e.g., of the procedure described earlier in conjunction with FIG. 15. Particularly, the memory 1730 may contain instructions executable by the processor 1720 whereby the network node 1700 is operative to, when implementing an API invoker: receive, from a CCF, service API status information indicating a status of a service API as part of a service API discovery procedure.

In an embodiment, the status of the service API may include active or inactive.

In an embodiment, the service API may be provided by an AS as an AEF.

In an embodiment, the memory 1730 may further contain instructions executable by the processor 1720 whereby the network node 1700 is operative to: transmit, to the CCF, a service API discover request. The operation of receiving the service API status information may include: receiving, from the CCF, a service API discover response that contains service API information of the service API, the service API information containing the service API status information.

In an embodiment, the memory 1730 may further contain instructions executable by the processor 1720 whereby the network node 1700 is operative to: select the service API when the status of the service API is active.

In an embodiment, the memory 1730 may further contain instructions executable by the processor 1720 whereby the network node 1700 is operative to: transmit, to the CCF, a request for subscribing, or updating subscription, for notification of AEF information associated with an AEF that is an AS providing the service API or an AEF type to which the AEF belongs; and receive, from the CCF, a notification of the AEF information. The AEF information includes a status of the AEF.

In an embodiment, the status of the AEF may indicate that the AEF is operating normally, is under maintenance, or has failed.

In an embodiment, the AEF information may further include one or more of: a type of the AEF, load information, capacity information, or a heartbeat configuration.

In an embodiment, the memory 1730 may further contain instructions executable by the processor 1720 whereby the network node 1700 is operative to: select the service API when the status of the service API is active and when the status of the AEF indicates that the AEF is operating normally and/or the load information indicates that a load on the AEF is lower than a threshold.

In an embodiment, the request for subscribing or updating may include an event filter for an identification of the AEF or the AEF type.

In an embodiment, the memory 1730 may further contain instructions executable by the processor 1720 whereby the network node 1700 is operative to: transmit, to the CCF, a request for subscribing, or updating subscription, for notification of service API status information associated with the service API or a service API type to which the service API belongs. The operation of receiving the service API status information may include: receiving, from the CCF, a notification of the service API status information.

In an embodiment, the request for subscribing or updating may include an event filter for an identification of the service API or the service API type.

In an embodiment, the memory 1730 may further contain instructions executable by the processor 1720 whereby the network node 1700 is operative to: transmit, to the CCF, an onboard API invoker request containing an indication that the CCF is to take control of API invocation influence or containing no indication on whether the API invoker or the CCF is to take control of API invocation influence; and receive, from the CCF, an onboard API invoker response containing a confirmation or indication that the CCF is to take control of API invocation influence.

In an embodiment, the memory 1730 may further contain instructions executable by the processor 1720 whereby the network node 1700 is operative to: transmit, to the CCF, an onboard API invoker request containing an indication that the API invoker is to take control of API invocation influence; and receive, from the CCF, an onboard API invoker response containing a confirmation that the API invoker is to take control of API invocation influence.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1720 causes the network node 1700 to perform the actions, e.g., of the procedure described earlier in conjunction with FIGS. 3, 5, 7, 8, 10, and 15.

The computer program product may be configured as a computer program code structured in computer program modules. The computer program modules could essentially perform the actions of the flow illustrated in FIGS. 3, 5, 7, 8, 10, and 15.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried in a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further provides the following embodiments based on the 3GPP TS 23.700-97, V0.3.0.

### 5.x Solution #X: Application Server Status Monitoring Via CAPIF

### 5.x.1 Description

This solution addresses KI #2 by providing enhanced CAPIF services for managing application server status. The CCF takes the responsibility to monitor application server status and application server service status. The CCF exposes the monitored AS server and service status to CCF service consumer (e.g. API invoker) via the enhanced service discovery procedure and event exposure procedure.

### 5.x.1.1 AS Status Monitoring

For the 3^{rd} party Application Server providing its service (also see KI #2 in 3GPP TR 23.700-98 [2370098]), it acts as AEF and the API provider domain function registration procedures (initial registration, update and deregistration) applies for the AS. As depicted in FIG. 4A and Table 5.x. 1.1-1 (with bold text), the AMF in the API provider domain shall register detailed AEF information for API provider domain function with role AEF in addition to existing API provider domain function registration information. The detailed AEF information includes AEF type (e.g. video transcoder), AEF status (e.g. normal operation, maintenance), load information, capacity information (e.g. CPU, memory; disk, network) and heartbeat configuration. The heartbeat configuration is used by CCF to check AS availability; it is not exposed to any other CAPIF entity consuming CCF service (e.g. API invoker).

TABLE 5.x.1.1-1
Registration request

| Information element | Status | Description |
|---|---|---|
| List of API provider domain | M | List of API provider domain functions including role |
| functions | | (e.g. AEF, APF, AMF) and, if required, specific |
| | | security information. |
| >AEF information | O | The AEF information includes AEF type, AEF |
| | | status, heartbeat interval, capacity, load, load |
| | | timestamp. Applicable for API provider domain |
| | | function with AEF role. |
| Security information | M | Information for CAPIF core function to validate the |
| | | registration request |

For registration update, the AEF information may be included as well if there is a need for update. The AEF status can be changed cither by AMF during registration update or by CCF during heartbeat process.

FIG. 6 shows the procedure of CCF offered service AEF for information subscription/update/unsubscription. The API invoker subscribes to the CCF for the desired AEF(s) and CCF validates the request and records the subscription information. If the CCF responds API invoker successfully during subscription, the API invoker will get the AEF information notification from the CCF if there is any change in the AEF information. The existing CAPIF event exposure service in clause 10.4 of 3GPP TS 23.222 can be re-used to support a new “AEF info update” event and the event filter may be AEF ID or AEF type.

### 5.x.1.2 AS Service Status Monitoring

For AS acting as an AEF and publishing its service API into CCF, the AS shall be able to update its service API status (active, inactive) in the CCF. Table 5.x.1.2-1 show the impact (with bold text) in the existing service API publish information flows in 3GPP TS 23.222 as example, the same addition applies for the service API update request and interconnection service API publish request.

TABLE 5.x.1.2-1
Service API publish request

| Information element | Status | Description |
|---|---|---|
| API publisher information | M | The information of the API publisher may include |
| | | identity, authentication and authorization |
| | | information |
| Service API information | M | The service API information includes the service |
| | | API name, service API type, service API status |
| | | (e.g. active, inactive), communication type, |
| | | description, Serving Area Information (optional), |
| | | AEF location (optional), interface details (e.g. IP |
| | | address, port number, URI), protocols, version |
| | | numbers, and data format. |
| Shareable information | O (see NOTE) | Indicates whether the service API or the service API |
| | | category can be published to other CCFs. And if |
| | | sharing, a list of CAPIF provider domain information |
| | | where the service API or the service API category |
| | | can be published is contained. |

(NOTE):
If the shareable information is not present, the service API is not allowed to be shared.

For service API discovery; the CCF consumer (e.g. API invoker) can discover the service API status via service API discovery procedure or be notified about the service API status change via CAPIF event exposure procedure. The APF can update the service API status to the CCF. Alternatively, the CCF can update the service API status based on its own probing.
NOTE: The CCF can act as an API invoker to probe service API. Probing details are out of the scope of the present study.

### 5.x.1.3 API Invocation Influence Control Considering AS Status

From CCF perspective, since it maintains both the status and load of the AEF being registered and each service API status the registered AEF supplies, the CCF may make its own determination to offer the service API(s) with active status within a normal operational and non-congested AEF to the CCF consumer (e.g. API invoker). How the congestion threshold is determined by the CCF is implementation specific.

Alternatively, the CCF may choose not to perform any filtering in providing the service API(s) to the API invoker. In this case, since API invoker has full knowledge on the discovered/notified API information (including status) and the notified AEF information (including load and status), the API invoker should be able to invoke service API properly based on its own determination.

In order to decide which entity (CCF or API invoker) shall take the control of API invocation influence, as depicted in FIG. 12, the API invoker needs to include such intention in the onboarding API invoker request if it wants to take the control. The CCF should respect API invoker's intention so that to avoid filtering service APIs in the service API discovery considering AS status for the requesting API invoker and confirm the same in the response acknowledging to the API invoker. If such intention is not received from the API invoker and if CCF wants to take the control, the CCF shall include the API invocation influence control information indicating CCF intention in the onboarding API invoker response.

Table 5.x.1.3-1 and table 5.x.1.3-2 show the impact (with bold text) in the information flows used in API invoker onboarding procedure.

TABLE 5.x.1.3-1
Onboard API invoker request

| Information element | Status | Description |
|---|---|---|
| Onboarding information | M | The information of the API invoker including |
| | | enrolment details, required for onboarding |
| APIs for enrollment | O | List of APIs being enrolled for. |
| API invocation influence | O | Indicate whether API invoker takes the control |
| control information | | for API invocation influence considering AS |
| | | status. |

TABLE 5.x.1.3-2
Onboard API invoker response

| Information element | Status | Description |
|---|---|---|
| Onboarding status | M | The result of onboarding request i.e., success |
| | | indication is included if the API invoker is granted |
| | | permission otherwise failure. |
| Enrolled information | O | Information from the provisioned API invoker profile |
| | (see NOTE 1) | which may include information to allow the API |
| | | invoker to be authenticated and to obtain |
| | | authorization for service APIs |
| Service API information | O | The service API information includes the service |
| | (see NOTE 2) | API name, service API type, communication type, |
| | | description, Serving Area Information (optional), |
| | | AEF location (optional), interface details (e.g. IP |
| | | address, port number, URI), protocols, version |
| | | numbers, and data format. |
| API invocation influence | O (NOTE 2) | Indicate whether CAPIF and which CAPIF entity |
| control information | | (i.e. API invoker or CCF) take the control for API |
| | | invocation influence considering AS status. |
| Reason | O | This element indicates the reason when onboarding |
| | (see NOTE 3) | status is failure. |

(NOTE 1):
Information element shall be present when onboarding status is successful.
(NOTE 2):
Information element may be present when onboarding status is successful.
(NOTE 3):
Information element shall be present when onboarding status is failure.

1-20. (canceled)

21. A method in a Common Application Programming Interface ‘API’ Framework ‘CAPIF’ Core Function, CCF, comprising:
receiving, from an API Publishing Function, APF, a service API publish request or service API update request containing service API status information indicating a status of a service API, and
indicating, to an API invoker or another CCF, the service API status information as part of a service API discovery procedure;
wherein the service API status information is carried in service API information.

22. (canceled)

23. The method of claim 21, wherein the status of the service API comprises active or inactive.

24. (canceled)

25. The method of claim 21, further comprising:
transmitting, to another CCF, an interconnection API publish request containing the service API status information.

26. The method of claim 21, wherein the service API discovery procedure further comprises:
receiving, from an API invoker or the other CCF, a service API discover request; and
transmitting, to the API invoker or the other CCF, a service API discover response based on the service API status information.

27. The method of claim 26, wherein said transmitting the service API discover response based on the service API status information comprises:
transmitting the service API discover response that contains service API information of the service API, the service API information containing the service API status information.

28. (canceled)

29. The method of claim 26, wherein said transmitting the service API discover response based on the service API status information comprises:
transmitting the service API discover response that contains service API information of the service API when the status of the service API is active

30. (canceled)

31. The method of claim 26, further comprising:
receiving, from an API Management Function, AMF, a registration request or registration update request containing API Exposing Function, AEF, information on an AEF that is an Application Server, AS, providing the service API, the AEF information comprising a status of the AEF.

32-37. (canceled)

38. The method of claim 21, further comprising:
receiving, from an API invoker or another CCF, a request for subscribing, or updating subscription, for notification of service API status information associated with the service API or a service API type to which the service API belongs; and
transmitting, to the API invoker or the other CCF, a notification of the service API status information.

39. The method of claim 38, wherein the request for subscribing or updating comprises an event filter for an identification of the service API or the service API type.

40. A method in an Application Programming Interface, API, invoker, comprising:
receiving, from a Common API Framework ‘CAPIF’ Core Function, CCF, service API status information indicating a status of a service API as part of a service API discovery procedure.

41. The method of claim 40, wherein the status of the service API comprises active or inactive.

42. (canceled)

43. The method of claim 40, wherein the service API discovery procedure further comprises:
transmitting, to the CCF, a service API discover request,
wherein said receiving the service API status information comprises: receiving, from the CCF, a service API discover response that contains service API information of the service API, the service API information containing the service API status information.

44. (canceled)

45. The method of claim 43, further comprising:
transmitting, to the CCF, a request for subscribing, or updating subscription, for notification of API Exposing Function, AEF, information associated with an AEF that is an Application Server, AS, providing the service API or an AEF type to which the AEF belongs; and
receiving, from the CCF, a notification of the AEF information, the AEF information comprising a status of the AEF.

46-49. (canceled)

50. The method of claim 40, further comprising:
transmitting, to the CCF, a request for subscribing, or updating subscription, for notification of service API status information associated with the service API or a service API type to which the service API belongs,
wherein said receiving the service API status information comprises: receiving, from the CCF, a notification of the service API status information.

51. The method of claim 50, wherein the request for subscribing or updating comprises an event filter for an identification of the service API or the service API type.

52. The method of claim 40, further comprising:
transmitting, to the CCF, an onboard API invoker request containing an indication that the CCF is to take control of API invocation influence or containing no indication on whether the API invoker or the CCF is to take control of API invocation influence; and
receiving, from the CCF, an onboard API invoker response containing a confirmation or indication that the CCF is to take control of API invocation influence.

53. The method of claim 40, further comprising:
transmitting, to the CCF, an onboard API invoker request containing an indication that the API invoker is to take control of API invocation influence; and
receiving, from the CCF, an onboard API invoker response containing a confirmation that the API invoker is to take control of API invocation influence.

54. (canceled)

55. (canceled)
